(19) United States
(12) Patent Application Publication
(10) Pub. No.: US 2016/0076500 A1
(43) Pub. Date: Mar. 17, 2016

(54) FUEL SYSTEM WITH FUEL COOLING

(71) Applicant: Caterpillar Inc., Peoria, IL (US)

(72) Inventor: Daniel R. Ibrahim, Metamora, IL (US)

(21) Appl. No.: 14/488,794

(22) Filed: Sep. 17, 2014

(51) Int. Cl. F02M 53/04; F02M 61/16

(52) U.S. Cl. CPC F02M 53/043; F02M 61/16

(57) ABSTRACT

A fuel system for an engine including a cylinder, a cylinder head having a quill tube bore, and at least, one fuel injector, is provided. The fuel system comprises a common rail, a quill tube, and a connector. The quill tube is configured to connect the common rail to the at least one fuel injector to supply fuel from the common rail, wherein the quill tube is coupled to the cylinder head such that a portion of the quill tube is positioned inside the quill tube bore in the cylinder head defining a coolant jacket therebetween. The connector is configured to couple the quill tube to the cylinder head, and to hold the quill tube inside the quill tube bore. The connector includes at least one through hole configured to allow passage of the coolant to the coolant jacket.

### TECHNICAL FIELD

The present disclosure relates generally to a feel system. More specifically, the present disclosure relates to a fuel system with fuel cooling.

Internal combustion engines equipped with a common rail fuel system, have a plurality of fuel injectors. A typical fuel injector of the common rail fuel system may be connected to a common rail through a quill tube. The fuel injector may inject fuel into the cylinder in a controlled manner by means of valve arrangements, which in turn are controlled by an actuator. Each of the feel injectors may be capable of injecting a certain quantity of fuel into the cylinder at pre-determined time intervals.

The feel may be injected into the cylinder of the internal combustion engine at high pressures. At high pressures, the feel is compressed and hence, the temperature of the fuel is raised. A rise in fuel temperature raises the temperature within the fuel injector of the internal combustion engine during operation cycles. The existing method for common rail fuel systems is to increase injection pressures while injecting the fuel in the cylinder. This may increase the temperature of the fuel. The high temperatures of the fuel may result in oxidation of the feel, which in turn may lead to deposition of debris on various surfaces of the fuel injector.

The present idea is directed at solving one or more of the problems stated above.

### SUMMARY OF THE DISCLOSURE

The present disclosure is related to a fuel system for an internal combustion engine. The internal combustion engine includes a cylinder, a cylinder head having a quill tube bore, and at least one fuel injector. The fuel system further includes a common rail, a quill tube, and a connector. The quill tube is configured to connect the common rail to the at least one fuel injector, for delivering fuel from the common rail. The quill tube is coupled to the cylinder head such that a portion of the quid tube is positioned inside the quill tube bore in the cylinder head, defining a coolant jacket therebetween. The connector is configured to couple the quill tube to the cylinder head and hold the quill tube inside the quill tube bore. The connector includes at least one through hole. The at least, one through hole is configured to allow passage of a coolant to the coolant jacket.

### BRIEF DESCRIPTION OF THE DRAWINGS

FIG. 1 illustrates a schematic representation of an internal combustion engine with a fuel system, in accordance with the concepts of the present disclosure;

FIG. 2 illustrates a sectional view of the fuel system with a quill tube positioned in a cylinder head, in accordance with the concepts of the present disclosure; and

FIG. 3 illustrates one of the injectors of the fuel system, in accordance with the concepts of the present disclosure.

### DETAILED DESCRIPTION

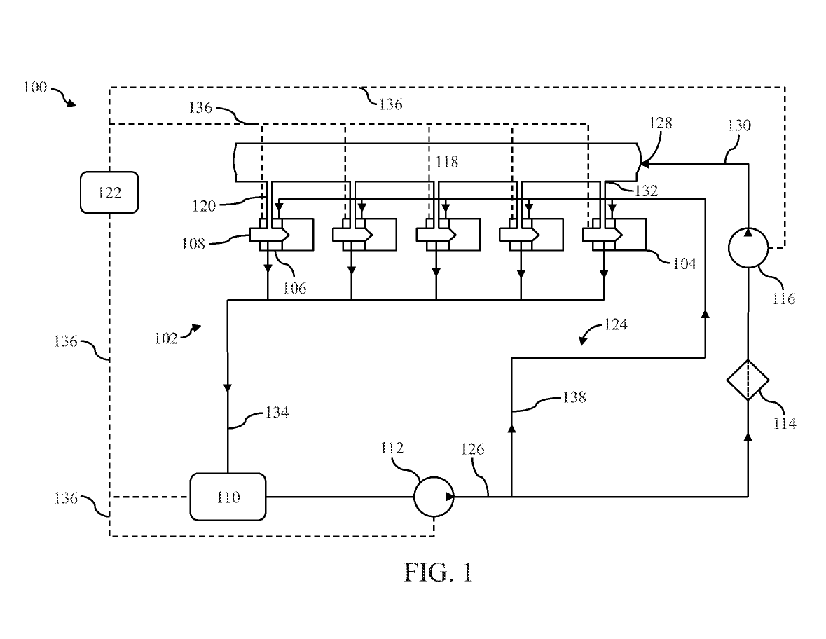

FIG. 1 illustrates a schematic representation of an internal combustion engine 100, in accordance with an aspect of the present disclosure. The internal combustion engine 100 may include a fuel system 102, a cylinder 104, and a cylinder head 106. The cylinder 104 may define a combustion chamber (not shown) for fuel injection and combustion. The cylinder 104 may be fitted with the cylinder head 106 which may be configured to house at least one fuel injector 108 for injection of the fuel into the cylinder 104.

The fuel system 102 may include the fuel injector 108, a fuel tank 110, a fuel transfer pump 112, a filter 114, a high pressure pump 116, a common rail 118, a quill tube 120, an electronic controller 122, and a coolant circuit 124. The fuel tank 110 is configured to store fuel, which may be any suitable fuel for burning in internal combustion engine 100, including, but not limited to, petroleum based distillate diesel fuel and/or bio-derived fuel. The fuel tank 110 may be fluidly connected to the fuel transfer pump 112. The fuel in the fuel tank 110 may be supplied to the fuel transfer pump 112. The fuel transfer pump 112 may be configured to supply the fuel through the filter 114 to the high pressure pump 116. The filtered fuel is supplied to the high pressure pump 116 through a fuel supply line 126. The high pressure pump 116 may be fluidly connected to an inlet 128 of the common rail 118. The high pressure pump 116 may supply the fuel to the inlet 128 of the common rail 118 through a high pressure fuel supply line 130. The common rail 118 is configured to supply the fuel to the fuel injector 108.

The common rail 118 may include at least one outlet 132 which is connected to the quill tube 120. The quill tube 120 is coupled to the cylinder head 106. The quill tube 120 is configured to facilitate supply of the fuel from the common rail 118 to the fuel injector 108. In an embodiment, the fuel injector 108 is positioned in the cylinder head 106 and the fuel injector 108 may be in fluid communication with a return line 134, as discussed below. The fuel returning through the return line 134 may be drained back into the fuel tank 110.

Further, the fuel system 102 includes the electronic controller 122. The electronic controller 122 may be configured to control the fuel system 102, with the help of a plurality of communication lines 136.

The fuel in the fuel tank 110 is pumped by the fuel transfer pump 112. The fuel transfer pump 112 supplies the low pressure fuel to the high pressure pump 116 through the filter 114, via the fuel supply line 126. The high pressure pump 116 then pumps the fuel further, to the inlet 128 of the common rail 118. The common rail 118 supplies fuel to the quill tube 120 through the outlet 132. The quill tube 120 renders the fuel supplied by the common rail 118 to the fuel injector 108. Injection of the fuel by the fuel injector 108 into the combustion chamber of the cylinder 104, may be controlled by the electronic controller 122. The electronic controller 122 is in communication, with the fuel injector 108 through the communication line 136.

Further, a portion of the low pressure fuel pumped by the fuel transfer pump 112 may be transferred to the fuel injector 108. This low pressure fuel transferred to the fuel injector 108 is used to cool the fuel injector 108 and herein after is referred to as a coolant. The path through which the coolant flows to cool the fuel injector 108, is referred as the coolant circuit 124. The coolant circuit 124 includes a coolant supply passage 138 and the return line 134. The coolant is transferred from the fuel transfer pump 112 to the fuel injector 108 through the coolant supply passage 138. The coolant circulates in the fuel injector 108, and cools the feel injector 108, by absorbing the heat of the fuel injector 108, which results in heating of the coolant. Upon cooling the fuel injector 108, the hot coolant flows back to the fuel tank 110 through the return line 134.

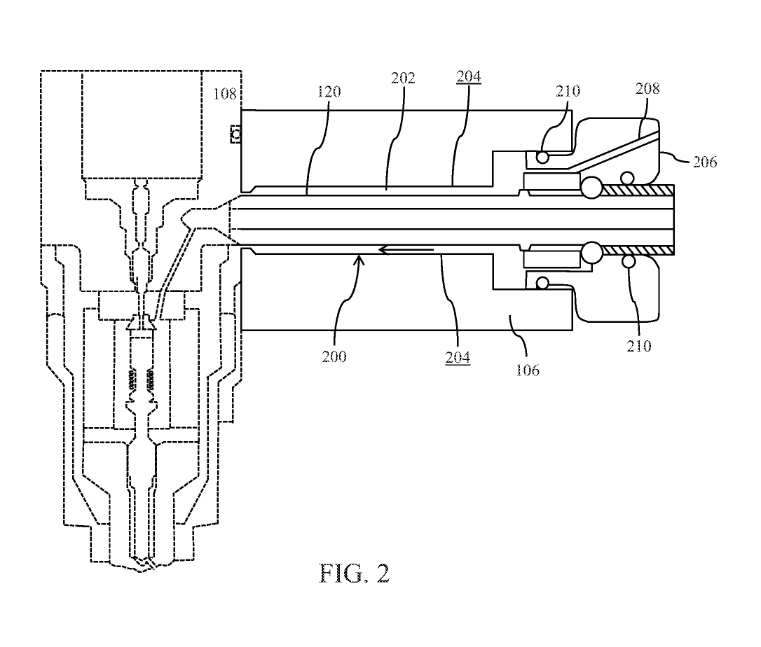

FIG. 2 illustrates a sectional view of the fuel system 102 with the quill tube 120 coupled to the cylinder head 106, in accordance with the concepts of the present disclosure. FIG. 2 is explained in conjunction with elements from FIG. 1. The cylinder head 106 includes a quill tube bore 200. The quill tube bore 200 is configured to house the quill tube 120. As discussed above, the quill tube 120 is coupled to the cylinder head 106 in such a way that a portion of the quill tube 120 is positioned inside the quill tube bore 200 in the cylinder head 106 defining a coolant jacket 202 therebetween. In other words, the space in the quill tube bore 200 surrounding the-quill tube 120 defines the coolant jacket 202. The coolant jacket 202 around the quill tube 120 is defined between a bore wall 204 of the quill tube bore 200 and the quill tube 120. The coolant jacket 202 around the quill tube 120 is configured to allow the flow of the coolant and thus cool the fuel in the quill tube 120.

Further, the cylinder head 106 is equipped with a connector 206 that is configured to couple the quill tube 120 to the cylinder head 106. The connector 206 is configured to hold the quill tube 120 inside the quill tube bore 200. The connector 206 includes at least one through hole 208. The through hole 208 is in fluid communication with the coolant-supply passage 142. The through hole 208 receives the coolant from the fuel tank 110 through the coolant supply passage 142 and allows passage of the coolant to the coolant jacket 202. The through hole 208 is in fluid communication with the coolant jacket 202 in the quill tube bore 200 of the cylinder head 106.

In an embodiment the fuel system 102 may be provided with a plurality of seals 210. The plurality of seals 210 may be provided to seal the connector 206 with the cylinder head 106 and the quill tube 120.

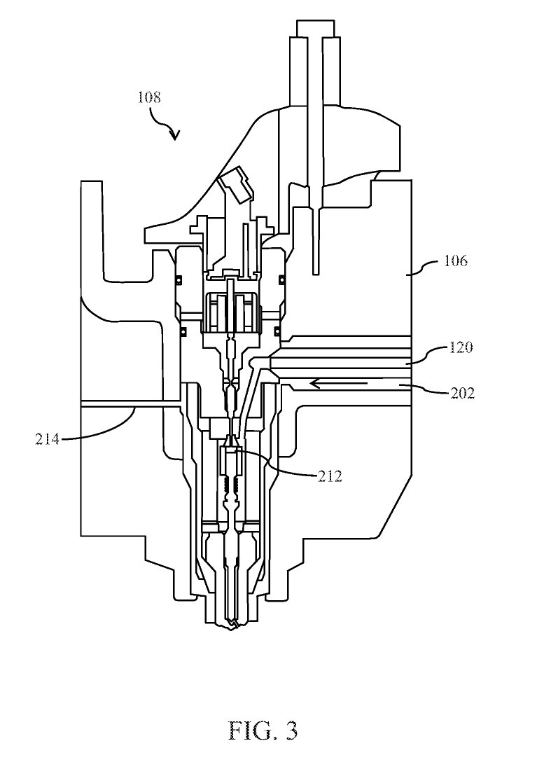

FIG. 3 illustrates one of the injectors of the fuel system 102 in detail, in accordance with the concepts of the present disclosure. FIG. 3 is explained in conjunction with elements from FIG. 1 and FIG. 2. As mentioned above, the fuel injector 108 is positioned within the cylinder head 106. The fuel injector 108 may include a pressure chamber 212. The pressure chamber 212 may be fluidly connected to the quill tube 120. The quill tube 120 is configured to provide high pressure fuel from the common rail 118 to the pressure chamber 212.

Further, the fuel injector 108 may house a plurality of fuel, channels 214 which are in fluid communication with the coolant jacket 202. The fuel channel 214 receives the coolant from the coolant jacket 202 and allow flow of the coolant to cool the fuel injector 108. Therefore, circulation of the coolant in the fuel channel 214 in the fuel injector 108 decreases the temperature of the fuel injector 108. After the coolant circulates in the fuel channel 214 and cools the fuel injector 108, the temperature of the coolant increases. Hence, there is a need to route the hot coolant out of the fuel injector 108. As discussed above, for this purpose, the fuel system 102 is provided with, the return line 134. The return line 134 is in fluid communication with the fuel channel 214 in the fuel injector 108. The return fine 134 is configured to return the coolant from the fuel channel 214 to the fuel tank 110.

During an injection event, the electronic controller 122 may send signals for the fuel injector 108 to inject fuel into the combustion chamber of the cylinder 104. Injection of high pressure fuel from the common rail 118 to the fuel injector 108 may increase the temperature of the fuel injector 108. In an embodiment, the temperature of the fuel injector 108 may be monitored by a plurality of temperature sensors (not shown) in control communication with the electronic controller 122.

### INDUSTRIAL APPLICABILITY

The present disclosure relates to fuel injectors in internal combustion engines. The disclosure is directed, to fuel injector operating at relatively high fuel injection pressures. The present disclosure provides the fuel system 102 with a provision for internal fuel cooling. The disclosed fuel system 102 is equipped with the through hole 208 in the connector 206 to deliver the low pressure coolant. In one embodiment, the internal combustion engine 100 may adapt a pumping source to pump the low pressure fuel or the coolant from the fuel tank 110. A flow of the low pressure coolant is provided to cool the met injector 108 associated with the internal combustion engine 100. The through hole 208 In the connector 206 may receive low pressure coolant from the fuel tank 110 (shown in FIG. 1) via the coolant supply passage 138. The through hole 208 delivers the low pressure coolant to the coolant jacket 202 around the quill tube 120. The low pressure coolant flows through the coolant jacket 202 to the fuel channel 214 in the fuel injector 108, to cool the fuel injector 108. Also, heat from the fuel in the quill tube 120 is transferred to the coolant flowing through the coolant jacket 202 around the quill tube 120, and thereby cooling the fuel in the quill tube 120. Further, the coolant flows from the coolant jacket 202 to the fuel channel 214 in the fuel injector 108 and the heat from the fuel injector 108 is transferred to the coolant and thereby the fuel injector 108 is cooled.

In an embodiment, the temperature of components within the fuel injector 108 of the internal combustion engine 100 may be maintained below a certain predetermined temperature. Current internal combustion engines follow the trend of high fuel injection pressures. High fuel injection pressures may result in increase in temperature of the fuel and the fuel injector 108. An additional effect of high fuel injection pressures is formation of debris on internal components of the fuel injector 108. The debris formation may be a result of evaporation and oxidation of lighter fuel compounds and deposition of heavier fuel compounds, at high fuel temperatures. Internal cooling of the fuel injector 108 and fuel flowing through the quill tube 120, as described herein, reduces the deposition of heavier fuel compounds of the fuel on the internal components of the fuel injector 108, This may preserve optimal performance of the fuel injector 108.

The present, description is for illustrative purposes only and should not be construed to narrow the breadth of the present disclosure in any way. Thus, those skilled in the art will appreciate that various modifications might be made to the presently disclosed embodiments without departing from the fall and fair scope and spirit of the present disclosure. Other aspects, features, and advantages will be apparent upon an examination of the attached drawings and appended claim.

What is claimed is:

1. A fuel system for an internal combustion engine, the internal combustion engine including; a cylinder, a cylinder head having a quill tube bore, at least one fuel injector positioned in the cylinder head wherein the at least one fuel injector is configured to inject fuel into the cylinder, the fuel system comprising:
a common rail, wherein the common rail is configured to deliver fuel to the at least one fuel injector;
a quill tube configured to connect the common rail to the at least one fuel injector to supply fuel, from the common rail, wherein the quill tube is coupled to the cylinder head such that a portion of the quill tube is positioned inside the quill tube bore In the cylinder head defining a coolant jacket therebetween;
a connector configured to couple the quill tube to the cylinder head, and to hold the quill tube inside the quill tube bore; and
at least one through hole positioned inside the connector, wherein the at least one through hole is configured to allow passage of a coolant to the coolant jacket.
